(19) United States
(12) Patent Application Publication
(10) Pub. No.: US 2026/0297230 A1
(43) Pub. Date: Oct. 1, 2026

(54) PROCESS FOR THE PRODUCTION OF POLYVINYLIDENE FLUORIDE COPOLYMERS

(71) Applicant: Arkema Inc., King of Prussia, PA (US)

(72) Inventors: Andrew KAHN, King of Prussia, PA (US); Brian PETERSON, King of Prussia, PA (US); Yuanqin LIU, King of Prussia, PA (US); Francois BEAUME, King of Prussia, PA (US)

(21) Appl. No.: 19/480,858

(22) PCT Filed: May 3, 2024
(86) PCT No.: PCT/US2024/027649

§ 371 Date: Nov. 3, 2025

(30) Foreign Application Priority Data
May 3, 2023 (EP) 23.171382.7

(51) Int. Cl. C08F 214/22; C09J 127/20; H01M 10/0525; H01M 50/426

(52) U.S. Cl. CPC C08F 214/22; C09J 127/20; H01M 50/426; C08F 2800/20; H01M 10/0525

(57) ABSTRACT

The present application relates to a copolymer comprising recurring units derived from vinylidene fluoride and recurring units derived from a fluorinated monomer M1; said copolymer having a melting temperature Tm defined by the relationship: (154.45−1.9472*x)−3<Tm (° C.)<(154.45−1.9472*x)+3 wherein x is the weight content of said fluorinated monomer MI expressed as percent based on the total weight of said copolymer; the melting temperature being measured by DSC according to the ASTM E794-06 standard test method. The present application also relates to the use of said composition in various technical fields.

### TECHNICAL FIELD

The present invention relates to copolymers of vinylidene fluoride and a fluorinated monomer. In particular, the present invention relates to a process for preparing said copolymer. The present invention also relates to the use of said copolymer.

### BACKGROUND OF THE INVENTION

Polyvinylidene fluoride (PVDF) is a highly crystalline, chemically resistant engineering thermoplastic fluoropolymer having a typical useful temperature range from −15° C. up to 150° C. Although the glass transition temperature (Tg) for PVDF resins, which normally defines low temperature performance, is near −40° C., in practice, the useful low temperature range for PVDF under impact applications is higher than the Tg. PVDF resins becomes increasingly brittle as its glass transition temperature is approached resulting in poor low-temperature impact resistance. PVDF also loses its flexibility and becomes more rigid at these lower temperatures. It is generally recognized that PVDF resin's low temperature usefulness ranges between +5 and −15° C.

Low temperature properties of PVDF can be improved by introducing co-monomers during polymer synthesis, to form PVDF copolymers. Copolymers of VDF and perfluoroalkyl vinyl ether (PAVE) have been synthesized as curable elastomers (U.S. Pat. No. 3,136,745) showing good low-temperature performance. Copolymers of vinylidene fluoride (VDF) and hexafluoropropylene (HFP) are shown in U.S. Pat. Nos. 4,076,929 and 4,569,978 to provide better low temperature performance. CN114163572 discloses the preparation of core-shell vinylidene fluoride copolymer. These copolymers are formed by adding the comonomer in a continuous mixed monomer feed to form random copolymers. The problem with these better low-temperature impact PVDF copolymers is that they also have significantly lower melting temperatures than PVDF homopolymers, reducing their useful temperature range.

One method used to optimize PVDF copolymer properties is to make a copolymer by altering the monomer feed during the polymerization, forming an initial polymer that is high in VDF monomer units, generally above 90 wt % VDF, then adding a co-monomer to the reactor at a point well into the polymerization to produce a copolymer. The VDF-rich polymer and copolymer, if properly selected and in sufficient quantity, will form distinct phases, resulting in an intimate heterogeneous copolymer. A heterogeneous PVDF copolymer is one having two (or more) distinct phases, with a polyvinylidene fluoride rich phase, and a PVDF copolymer phase that is comonomer-rich. These phases can form as a non-continuous structure (having discrete rubber domains). For example, US20200407543 discloses a heterogeneous composition comprising two or more distinct phases. Alternatively, heterogeneous copolymer having co-continuous phases, i.e. having two (or more) continuous phases that are intimately intertwined with each other and cannot be physically separated, can be produced. For example, U.S. Pat. No. 10,570,230 discloses a heterogeneous copolymer composition comprising two or more co-continuous phases wherein said co-continuous phases comprise: a) from 25 to 50 weight percent of a first co-continuous phase comprising 90 to 100 weight percent of vinylidene fluoride monomer units and 0 to 10 weight percent of other fluoromonomer units, and b) from greater than 50 weight percent to 75 weight percent of a second co-continuous phase comprising from 65 to 95 weight percent of vinylidene fluoride monomer units and an effective amount of one or more comonomers selected from the group consisting of hexafluoropropylene and perfluoroalkylvinyl ether to cause the second co-continuous phase to phase separate from the first continuous phase; wherein the heterogeneous copolymer composition comprises a melting point from 150° C. and 175° C. WO2022114044 also discloses the preparation of vinylidene fluoride copolymer for secondary battery containing high amount of hexafluoropropene. However, high amount of hexafluoropropene leads to the dissolution of the copolymer in the electrolyte in the secondary battery.

There is still a need for PVDF polymers having a combination of a high melting point for good melt processing, improved low temperature properties and improved dry adhesion. The aim of the present invention is to provide a composition having reasonable swelling and high melting point in order to increase dry adhesion and therefore to improve production efficiency. Surprisingly, it has now been found a process for producing copolymer, wherein the copolymer shows a good compromise between melt processability, reasonable swelling, and good adhesion properties.

### SUMMARY OF THE INVENTION

In a first aspect, the present invention provides a copolymer comprising recurring units derived from vinylidene fluoride and recurring units derived from a fluorinated monomer M1; said copolymer having a melting temperature Tm defined by the relationship:

(154.45−1.9472*x)−3<Tm (° C.)<(154.45−1.9472*x)+3

wherein x is the weight content of said fluorinated monomer M1 expressed as percent based on the total weight of said copolymer; the melting temperature being measured by DSC according to the ASTM E794-06 (2018) standard test method; wherein the fluorinated monomer M1 is hexafluoropropene and wherein the weight content of hexafluoropropene based on the total weight of said copolymer is lower than 11 wt %. For example, when the weight content of said fluorinated monomer M1 in the copolymer is 10 wt %, then x is 10 in the above-mentioned relationship. The present invention allows the preparation of a copolymer having a melting temperature lower than the one obtained with other processes, at the same content of said fluorinated monomer M1. The copolymer so-obtained requires lower pressing temperature when it is used in the preparation of a separator or an electrode for Li-ion battery. However, the swelling is controlled due to the lower content of said fluorinated monomer M1 in the copolymer and therefore the dissolution of the copolymer in the electrolyte is avoided. Compared to other copolymers having the same content of said fluorinated monomer M1, particularly hexafluoropropene, the copolymer of the present invention has a lower melting temperature, lower swelling in presence of an electrolyte and better adhesion. A weight content of hexafluoropropene lower than 11 wt % is advantageously preferred when the copolymers are used in a separator. Copolymers having HFP content greater than 11 wt % tend to dissolve in the electrolyte used in the Li-ion secondary battery.

In a preferred embodiment, the weight content of said fluorinated monomer M1 is from 0.1 wt % to 11 wt % based on the total weight of the copolymer, advantageously from 0.5 wt % to 11 wt % based on the total weight of the copolymer, preferably from 1 to 11 wt % based on the total weight of the copolymer, more preferably from 2 to 10.5 wt % based on the total weight of the copolymer, in particular from 4 to 10 wt %, more particularly from 4.5 to 10 wt % based on the total weight of the copolymer.

In a preferred embodiment, the copolymer has a heat of fusion ΔH defined by the relationship: (34.517−1.0125*x)−2.2<ΔH (J/g)<(34.517−1.0125*x)+2.2; wherein x is the weight content of said fluorinated monomer M1 expressed as percent based on the total weight of said copolymer; the heat of fusion being determined by DSC according to the ASTM E793-06 standard test method. In a preferred embodiment, said copolymer comprises recurring units derived from a hydrophilic monomer M2 of formula R¹R²C═C(R³)C(O)R (I) wherein R¹, R² and R³ are independently selected from the group consisting of H and C₁-C₅ alkyl; R is selected from the group consisting of —NHC(CH₃)₂CH₂C(O)CH₃, —NR′R″ or —OR′ wherein R′ and R″ are independently selected from the group consisting of H and C₁-C₁₈ alkyl groups, optionally substituted by one or more hydroxyl, carboxyl, thiol or amino functional group(s) or a five- to six-membered heterocycle comprising at least one nitrogen atom in the ring.

In a preferred embodiment, said copolymer comprises recurring units derived from a monomer bearing a functional group selected from the group consisting of carboxylic acid, carboxylic acid anhydride, carboxylic acid ester, epoxy groups, amide, hydroxyl, carbonyl, mercapto, sulfide, oxazoline, phenolic, ester, ether, siloxane, sulfonic, sulfuric, phosphoric or phosphonic.

In a preferred embodiment, said copolymer is in powder form.

In another aspect, the present invention provides the use of said copolymer as a seed for the preparation of an interpenetrating polymer network.

In another aspect, the present invention provides the use of said copolymer of the present invention in a separator for lithium-ion battery.

In another aspect, the present invention provides a process for preparing a copolymer comprising the steps of:
a) Charging to a reactor an initial charge comprising water, surfactant and a fluorinated monomer M1 and adding vinylidene fluoride to the reactor until the operating pressure is reached;
b) Initiating the polymerization by adding an initiator;
c) Continuously feeding vinylidene fluoride and optionally the initiator until all the vinylidene fluoride has been added to the reactor to form the copolymer;
d) Removing the copolymer from the reactor;
e) Optionally drying the copolymer to form a powder;
wherein the weight content of said fluorinated monomer M1 introduced in the reactor throughout the process is lower than 11% based on the total weight of vinylidene fluoride and said fluorinated monomer M1 introduced in the reactor throughout the process; and wherein the whole amount of said fluorinated monomer M1 used in the process is added to the reactor prior to step b).

In a preferred embodiment, said fluorinated monomer M1 is selected from the group consisting of hexafluoropropene, tetrafluoroethylene, chlorotrifluoroethylene, vinyl fluoride, pentafluoropropene, tetrafluoropropene, trifluoroethylene, perfluoromethyl vinyl ether, perfluoroethyl vinyl ether, perfluoropropyl vinyl ether.

In a preferred embodiment, said fluorinated monomer M1 is hexafluoropropene.

In a preferred embodiment, the surfactant is a non-ionic or non-fluorinated surfactant or non-ionic and non-fluorinated.

In a preferred embodiment, the surfactant comprises a polyethylene glycol segment and a polypropylene glycol segment, has a HLB value of 1 to 5 and preferably a weight average molecular weight of from 2500 to 10000 g·mol-1.

In a preferred embodiment, a hydrophilic monomer M2 is added in any one of steps a), b) and/or c), and said hydrophilic monomer M2 is of formula R¹R²C═C(R³)C(O)R (I) wherein R¹, R² and R³ are independently selected from the group consisting of H and C₁-C₅ alkyl; R is selected from the group consisting of —NHC(CH₃)₂CH₂C(O)CH₃, —NR′R′ or —OR′ wherein R′ and R″ are independently selected from the group consisting of H and C₁-C₁₈ alkyl groups, optionally substituted by one or more hydroxyl, thiol or amino functional group(s) or a five- to six-membered heterocycle comprising at least one nitrogen atom in the ring.

In another aspect, the present invention provides an article formed from the copolymer according to the present invention.

In another aspect, the present invention provides a separator for a lithium-ion battery comprising an adhesive layer on at least one side of a porous substrate, wherein the adhesive layer comprises the copolymer according to the present invention, and optionally inorganic particles.

In another aspect, the present invention provides a positive electrode composition or a negative electrode composition comprising the copolymer according to the present invention.

In another aspect, the present invention provides a coated substrate on which the copolymer according to the present invention is applied as a latex in water or as a solvent solution.

In another aspect, the present invention provides a porous membrane comprising the copolymer according to the present invention applied as a latex in water or as a solvent solution.

In another aspect, the present invention provides a copolymer comprising recurring units derived from vinylidene fluoride and recurring units derived from a fluorinated monomer M1; said copolymer having a melting temperature Tm defined by the relationship:

(154.45−1.9472*x)−3<Tm (° C.)<(154.45−1.9472*x)+3

wherein x is the weight content of said fluorinated monomer M1 expressed as percent based on the total weight of said copolymer; the melting temperature being measured by DSC according to the ASTM E794-06 (2018) standard test method; wherein the fluorinated monomer M1 is hexafluoropropene and wherein the weight content of hexafluoropropene based on the total weight of said copolymer is greater than 17 wt %. The copolymer of the present invention has better processability properties and can be used in several applications other than in a separator of a non-aqueous electrolyte Li-ion secondary battery. For example, the copolymer may be used in a solid-state battery or for the preparation of gel-like or solid electrolyte. The present invention allows the preparation of a copolymer having a melting temperature lower than the one obtained with other processes, at the same content of said fluorinated monomer M1, even at high content of said fluorinated monomer M1.

In a preferred embodiment, the weight content of said fluorinated monomer M1 is from 17 wt % to 50 wt % based on the total weight of the copolymer, preferably from 18 wt % to 45 wt % based on the total weight of the copolymer, particularly from 18 to 40 wt % based on the total weight of the copolymer.

In another aspect, the present invention provides a process for preparing a copolymer, comprising the steps of:
a) Charging to a reactor an initial charge comprising water, non-ionic and non-fluorinated surfactant, a fluorinated monomer M1 and adding vinylidene fluoride to the reactor until the operating pressure is reached;
b) Initiating the polymerization by adding an initiator;
c) Continuously feeding vinylidene fluoride and optionally the initiator until all the vinylidene fluoride has been added to the reactor to form the copolymer;
d) Removing the copolymer from the reactor;
e) Optionally drying the copolymer to form a powder;
wherein the weight content of said fluorinated monomer M1 introduced in the reactor throughout the process is greater than 17 wt % based on the total weight of vinylidene fluoride and said fluorinated monomer M1 introduced in the reactor throughout the process; wherein the whole amount of said fluorinated monomer M1 used in the process is added to the reactor prior to step b); and wherein said non-ionic and non-fluorinated surfactant comprises a polyethylene glycol segment and a polypropylene glycol segment, has a HLB value of 1 to 5 and preferably a weight average molecular weight of from 2500 to 10000 g·mol-1.

In a preferred embodiment, said fluorinated monomer M1 is hexafluoropropene.

In a preferred embodiment, the weight content of said fluorinated monomer M1 introduced in the reactor throughout the process is from 17 wt % to 50 wt %, preferably from 18 wt % to 45 wt %, particularly from 18 to 40 wt % based on the total weight of vinylidene fluoride and said fluorinated monomer M1 introduced in the reactor throughout the process.

In another aspect, the present invention provides an article formed from the copolymer to the present invention.

### BRIEF DESCRIPTION OF THE DRAWINGS

FIG. 1 is a SEM image of the copolymer obtained according to a particular embodiment of the present invention.

FIG. 2 and FIG. 3 are graphs illustrating the melting temperature of the copolymer of the present invention or comparative copolymers as a function of the weight content (%) of the fluorinated monomer M1 according to one embodiment of the present invention.

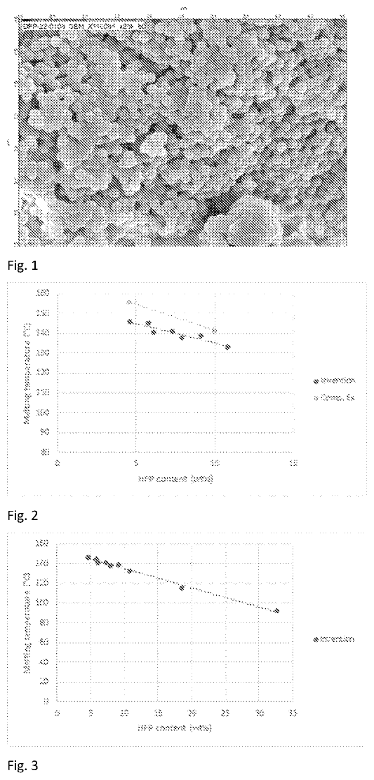

### DETAILED DESCRIPTION OF THE INVENTION

The invention relates to a copolymer comprising recurring units derived from vinylidene fluoride and fluorinated monomer M1. The invention also relates to a process for forming the novel copolymer, and uses of the copolymer. Unless otherwise noted, all percentages are weight percentages.

### Composition

As mentioned above, in a first aspect of the present invention, a copolymer is provided. In a preferred embodiment, said copolymer comprises at least two different types of recurring units. The copolymer of the present invention comprises at least recurring units derived from vinylidene fluoride. The copolymer of the present invention further comprises at least recurring units derived from a fluorinated monomer M1. The fluorinated monomer M1 is different from vinylidene fluoride. The fluorinated monomer M1 comprises at least one fluorine atom. The fluorinated monomer M1 may also comprise bromine, chlorine or iodine atoms.

Hence, the copolymer of the present invention comprises recurring units derived from vinylidene fluoride and recurring units derived from a fluorinated monomer M1. Said copolymer has a melting temperature defined by the relationship:

(154.45−1.9472*x)−3<Tm (° C.)<(154.45−1.9472*x)+3

wherein x is the weight content expressed as percent of said fluorinated monomer M1 based on the total weight of said copolymer. The melting temperature is measured by DSC according to the ASTM E794-06 (2018) standard test method. Preferably, said copolymer has a melting temperature defined by the relationship: (154.45−1.9472*x)−2.7<Tm (° C.)<(154.45−1.9472*x)+2.7. In another embodiment, the copolymer has a melting temperature defined by the relationship: (160.04−2.5108*x)−5.5<Tm (C)<(160.04−2.5108*x)+5.5; advantageously (160.04−2.5108*x)−5<Tm (° C.)<(160.04−2.5108*x)+5; preferably (160.04−2.5108*x)−4<Tm (C)<(160.04−2.5108*x)+4; in particular (160.04−2.5108*x)−3<Tm (° C.)<(160.04−2.5108*x)+3; wherein x is the weight content expressed as percent of said fluorinated monomer M1 based on the total weight of said copolymer.

In comparison with other previously known copolymers of vinylidene fluoride/fluorinated monomer, the copolymer according to the present invention offers the following advantages: lower melting temperature allows easier manufacturing for typical molding processes; lower swelling allows the improvement of battery efficiency. An improved adhesion is also obtained with the copolymers of the present invention.

The weight content of said fluorinated monomer M1 in said copolymer may be from 1 to 66 wt % based on the total weight of the copolymer. Advantageously, the weight content of said fluorinated monomer M1 in said copolymer may be greater than 1 wt %, or greater than 2 wt %, or greater than 3 wt %, or greater than 4 wt %, or greater than 5 wt %, or greater than 6 wt %, or greater than 7 wt %, or greater than 8 wt %, or greater than 9 wt %, or greater than 10 wt %, or greater than 11 wt %, or greater than 12 wt %, or greater than 13 wt %, or greater than 14 wt %, or greater than 15% based on the total weight of the copolymer.

Advantageously, the weight content of said fluorinated monomer M1 may be lower than 66 wt %, or lower than 64 wt %, or lower than 62 wt %, or lower than 60 wt %, or lower than 58 wt %, or lower than 56 wt %, or lower than 54 wt % or lower than 52 wt % or lower than 50 wt % or lower than 48 wt % or lower than 46 wt % or lower than 44 wt % or lower than 42 wt % or lower than 40 wt %.

The weight content of the fluorinated monomer M1 in the copolymer of the present invention may be in the range of any of the above-mentioned values.

The weight content of said fluorinated monomer M1 may be lower than 11 wt % based on the total weight of the copolymer. Advantageously, the weight content of said fluorinated monomer M1 is from 0.1 wt % to 11 wt % based on the total weight of the copolymer, preferably from 0.5 wt % to 11 wt % based on the total weight of the copolymer, more preferably from 1 to 11 wt % based on the total weight of the copolymer, most preferably from 2 to 10.5 wt % or 2 to 10 wt % based on the total weight of the copolymer, in particular from 3 to 10 wt % based on the total weight of the copolymer, more particularly from 4 to 10 wt % based on the total weight of the copolymer, most particularly from 4.5 to 10 wt % or 4.5 to 9.5 wt % based on the total weight of the copolymer.

In another preferred embodiment, the weight content of said fluorinated monomer M1 may be from 17 wt % to 50 wt % based on the total weight of the copolymer, preferably from 18 wt % to 45 wt % based on the total weight of the copolymer, particularly from 18 to 40 wt % based on the total weight of the copolymer.

The weight content of said fluorinated monomer M1 may be from 2 to 66 wt % based on the total weight of the copolymer, or from 2% to 65 wt % based on the total weight of the copolymer, or from 2% to 60 wt % based on the total weight of the copolymer or from 2% to 55 wt % based on the total weight of the copolymer or from 2% to 50 wt % based on the total weight of the copolymer or from 2% to 45 wt % based on the total weight of the copolymer or from 2% to 40 wt % based on the total weight of the copolymer or from 2% to 35 wt % based on the total weight of the copolymer or from 2% to 30 wt % based on the total weight of the copolymer or from 2% to 25 wt % based on the total weight of the copolymer or from 2% to 20 wt % based on the total weight of the copolymer or from 2% to 15 wt % based on the total weight of the copolymer.

The he weight content of said fluorinated monomer M1 may be from 5 to 66 wt % based on the total weight of the copolymer, or from 5% to 65 wt % based on the total weight of the copolymer, or from 5% to 60 wt % based on the total weight of the copolymer or from 5% to 55 wt % based on the total weight of the copolymer or from 5% to 50 wt % based on the total weight of the copolymer or from 5% to 45 wt % based on the total weight of the copolymer or from 5% to 40 wt % based on the total weight of the copolymer or from 5% to 35 wt % based on the total weight of the copolymer or from 5% to 30 wt % based on the total weight of the copolymer or from 5% to 25 wt % based on the total weight of the copolymer or from 5% to 20 wt % based on the total weight of the copolymer or from 5% to 15 wt % based on the total weight of the copolymer.

Alternatively, the weight content of said fluorinated monomer M1 may be from 10 to 66 wt % based on the total weight of the copolymer, or from 10% to 65 wt % based on the total weight of the copolymer, or from 10% to 60 wt % based on the total weight of the copolymer or from 10% to 55 wt % based on the total weight of the copolymer or from 10% to 50 wt % based on the total weight of the copolymer or from 10% to 45 wt % based on the total weight of the copolymer or from 10% to 40 wt % based on the total weight of the copolymer or from 10% to 35 wt % based on the total weight of the copolymer or from 10% to 30 wt % based on the total weight of the copolymer.

Alternatively, the weight content of said fluorinated monomer M1 may be from 15 to 66 wt % based on the total weight of the copolymer, or from 15% to 65 wt % based on the total weight of the copolymer, or from 15% to 60 wt % based on the total weight of the copolymer or from 15% to 55 wt % based on the total weight of the copolymer or from 15% to 50 wt % based on the total weight of the copolymer or from 15% to 45 wt % based on the total weight of the copolymer or from 15% to 40 wt % based on the total weight of the copolymer.

In a preferred embodiment, the fluorinated monomer M1 is selected from the group consisting of hexafluoropropene, tetrafluoroethylene, chlorotrifluoroethylene, vinyl fluoride, pentafluoropropene, tetrafluoropropene, trifluoroethylene, 1,2-difluoroethylene and perfluoroalkyl vinyl ethers, perfluoro (1,3-dioxole), perfluoro (2,2-dimethyl-1,3-dioxole) (PDD), a monomer of formula CF₂═CFOCF₂CF(CF₃)OCF₂CF₂X wherein X is SO₂F, CO₂H, CH₂OH, CH₂OCN or CH₂OPO₃H; a monomer of formula CF₂═CFOCF₂CF₂SO₂F; a monomer of formula F(CF₂)nCH₂OCF═CF₂ wherein n is 1, 2, 3, 4 or 5; a monomer of formula R¹CH₂OCF═CF₂ wherein R¹ is hydrogen atom or F(CF₂)m and m is 1, 2, 3 or 4; a monomer of formula R²OCF═CH₂ wherein R² is F(CF₂)p et p is 1, 2, 3 or 4; perfluorobutylethylene (PFBE); trifluoropropene, hexafluoroisobutylene, perfluorobutylethylene, bromotrifluoroethylene, chlorofluoroethylene, chlorotrifluoropropene and 2-trifluoromethyl-3,3,3-trifluoro-1-propene or mixture thereof.

The perfluoroalkyl vinyl ethers useful in the invention are those having the structure: CF₂═CF—O—Rf, where Rf is one or more perfluoroalkyl groups selected from —CF₃, —CF₂CF₃, and —CF₂CF₂CF₃. A preferred perfluoroalkyl vinyl ether is perfluoromethyl vinyl ether.

Among trifluoropropene, 3,3,3-trifluoropropene is preferred. Among tetrafluoropropene, 2,3,3,3-tetrafluoropropene and 1,3,3,3-tetrafluoropropene are preferred. Among pentafluoropropene, 1,1,3,3,3-pentafluoropropene and 1,2,3,3,3-pentafluoropropene are preferred. Chlorofluoroethylene refers to 1-chloro-1-fluoroethylene or 1-chloro-2-fluoroethylene; 1-chloro-1-fluoroethylene is preferred. Chlorotrifluoropropene refers to 1-chloro-3,3,3-trifluoropropene or 2-chloro-3,3,3-trifluoropropene.

Preferably, the fluorinated monomer M1 is selected from the group consisting of hexafluoropropene, tetrafluoroethylene, chlorotrifluoroethylene, vinyl fluoride, pentafluoropropene, tetrafluoropropene, trifluoroethylene and perfluoroalkyl vinyl ethers, or mixtures thereof.

More preferably, said fluorinated monomer M1 is selected from the group consisting of hexafluoropropene, tetrafluoroethylene, chlorotrifluoroethylene, fluoride, vinyl pentafluoropropene, tetrafluoropropene, trifluoroethylene, perfluoromethyl vinyl ether, perfluoroethyl vinyl ether and perfluoropropyl vinyl ether; or mixtures thereof.

In particular, said fluorinated monomer M1 is selected from the group consisting of hexafluoropropene, perfluoromethyl vinyl ether, perfluoroethyl vinyl ether and perfluoropropyl vinyl ether, or mixtures thereof. More particularly, said fluorinated monomer M1 is selected from the group consisting of hexafluoropropene and perfluoromethyl vinyl ether, or mixtures thereof. In a preferred embodiment, the fluorinated monomer M1 is hexafluoropropene.

The weight content of recurring units derived from vinylidene fluoride may be from 40 to 99.9 wt. % based on the total weight of said copolymer, preferably from 50 to 90.9 wt. % based on the total weight of said copolymer.

In a preferred embodiment, the weight content of recurring units derived from vinylidene fluoride is from 89 to 99.9 wt. % based on the total weight of said copolymer, advantageously from 89 to 99.5 wt %, preferably from 89 to 99 wt. %, more preferably from 90 wt % to 98 wt % or 89.5 to 98 wt %, most preferably from 90 to 97 wt %, in particular from 90 to 96 wt %, more particular from 90 to 95.5 wt %, most particular from 90.5 to 95.5 wt % based on the total weight of said copolymer. In another preferred embodiment, the weight content of recurring units derived from vinylidene fluoride is from 50 to 83 wt %, preferably from 55 to 82 wt %, in particular from 60 to 82 wt % based on the total weight of said copolymer.

In a preferred embodiment, the copolymer has a heat of fusion ΔH defined by the relationship: (34.517−1.0125*x)−2.2<ΔH (J/g)<(34.517−1.0125*x)+2.2; wherein x is the weight content of said fluorinated monomer M1 expressed as percent based on the total weight of said copolymer; the heat of fusion being determined by DSC according to the ASTM E794-06 (2018) standard test method. Preferably the copolymer has a heat of fusion ΔH defined by the relationship: (34.517−1.0125*x)−1.0<ΔH (J/g)<(34.517−1.0125*x)+1.0; wherein x is the weight content of said fluorinated monomer M1 expressed as percent based on the total weight of said copolymer; the heat of fusion being determined by DSC according to the ASTM E794-06 (2018) standard test method.

In a preferred embodiment, the copolymer has a melt viscosity of 1 to 50 kilopoise (kP), advantageously of 1 to 40 kP, preferably 1 to 32 kP, more preferably of 2 to 30 kP, in particular of 3 to 25 kP, more particularly of 5 to 30 kP as measured according to ASTM method D3835 measured at 232° C. and 100 sec⁻¹. The higher molecular weight copolymers tend to be tougher and have advantages in low temperature impact, however lower melt viscosity copolymer is useful in some application by allowing for higher speed melt processing.

In one embodiment, said copolymer consists in recurring units derived from vinylidene fluoride and recurring units derived from said fluorinated monomer M1.

In one embodiment, said copolymer optionally comprises recurring units derived from a hydrophilic monomer M2 of formula R¹R²C═C(R³)C(O)R (I) wherein R¹, R² and R³ are independently selected from the group consisting of H and C₁-C₅ alkyl; R is selected from the group consisting of —NHC(CH₃)₂CH₂C(O)CH₃, —NR′R″ or —OR′ wherein R′ and R″ are independently selected from the group consisting of H and C₁-C₁₈ alkyl groups, optionally substituted by one or more hydroxyl, carboxyl thiol or amino functional group(s) or a five- to six-membered heterocycle comprising at least one nitrogen atom in the ring.

In a preferred embodiment, said hydrophilic monomer M2 is of formula R¹R²C═C(R³)C(O)R (I) wherein R¹, R² and R³ are independently selected from the group consisting of H and C₁-C₅ alkyl; R is selected from the group consisting of —NHC(CH₃)₂CH₂C(O)CH₃, —NR′R″ or OR′ wherein R′ and R″ are independently selected from the group consisting of H and C₁-C₁₅ alkyl optionally substituted by one or more hydroxyl, carboxyl thiol or amino functional group(s) or a five- to six-membered heterocycle comprising at least nitrogen atom in the ring. In a preferred embodiment, said hydrophilic monomer M2 is of formula R¹R²C═C(R³)C(O)R (I) wherein R¹, R² and R³ are independently selected from the group consisting of H and C₁-C₅ alkyl; R is selected from the group consisting of —NHC(CH₃)₂CH₂C(O)CH₃, —NR′R″ or OR′ wherein R′ and R″ are independently selected from the group consisting of H and C₁-C₁₀ alkyl optionally substituted by one or more hydroxyl, carboxyl, thiol or amino functional group(s) or a five- to six-membered heterocycle comprising at least nitrogen atom in the ring. In a preferred embodiment, said hydrophilic monomer M2 is of formula R¹R²C═C(R³)C(O)R (I) wherein R¹, R² and R³ are independently selected from the group consisting of H and C₁-C₅ alkyl; R is selected from the group consisting of —OR′ wherein R′ is selected from the group consisting of H and C₁-C₁₀ alkyl optionally substituted by one or more-OH or CO₂H functional group(s). In a preferred embodiment, said hydrophilic monomer M2 is of formula R¹R²C═C(R³)C(O)R (I) wherein R¹, R² and R³ are independently selected from the group consisting of H and C₁-C₃ alkyl; R is selected from the group consisting of —OR′ wherein R′ is selected from the group consisting of H and C₁-C₁₀ alkyl optionally substituted by one or more-OH or CO₂H functional group(s). In a more preferred embodiment, said hydrophilic monomer M2 is of formula R¹R²C═C(R³)C(O)R (I) wherein R¹, R² and R³ are independently selected from the group consisting of H and C₁-C₃ alkyl; R is selected from the group consisting of —OR′ wherein R′ is selected from the group consisting of H and C₁-C₅ alkyl optionally substituted by one or more-OH or CO₂H functional group(s). In a preferred embodiment, said hydrophilic monomer M2 is selected from the group consisting of acrylic acid, methacrylic acid, methyl acrylate, methyl methacrylate, ethyl acrylate, propyl acrylate, n-butyl acrylate, isobutyl acrylate, t-butyl acrylate, n-dodecyl acrylate, amyl acrylate, isoamyl acrylate, hexyl acrylate, 2-ethylhexyl acrylate, diacetone acrylamide, lauryl acrylate, n-octyl acrylate, ethyl methacrylate, propyl methacrylate, n-butyl methacrylate, isobutyl methacrylate, t-butyl methacrylate, n-dodecyl methacrylate, amyl methacrylate, isoamyl methacrylate, hexyl methacrylate, 2-ethylhexyl methacrylate, lauryl methacrylate, n-octyl methacrylate, 2-hydroxyethyl methacrylate, 2-hydroxypropyl acrylate, 4-hydroxybutyl methacrylate, 2-hydroxyethyl acrylate, carboxyethyl acrylate, acryloyloxyethyl succinate and combinations thereof. Among these, alkyl acrylates with an alkyl group having from 1 to 8 carbon atoms are preferred, and alkyl acrylates with an alkyl group having from 1 to 5 carbon atoms are more preferable. These compounds may be used alone or as a mixture of two or more. In a more preferred embodiment, said hydrophilic monomer M2 is selected from the group consisting of acrylic acid, methacrylic acid, methyl acrylate, methyl methacrylate, ethyl acrylate, propyl acrylate, n-butyl acrylate, isobutyl acrylate, t-butyl acrylate, amyl acrylate, isoamyl acrylate, ethyl methacrylate, propyl methacrylate, n-butyl methacrylate, isobutyl methacrylate, t-butyl methacrylate, amyl methacrylate, isoamyl methacrylate, 2-hydroxyethyl methacrylate, 2-hydroxypropyl acrylate, 4-hydroxybutyl methacrylate, 2-hydroxyethyl acrylate, carboxyethyl acrylate, acryloyloxyethyl succinate and combinations thereof; in particular selected from the group consisting of acrylic acid, methacrylic acid, methyl acrylate, methyl methacrylate, ethyl acrylate, propyl acrylate, ethyl methacrylate, propyl methacrylate, 2-hydroxyethyl methacrylate, 2-hydroxypropyl acrylate, 4-hydroxybutyl methacrylate, 2-hydroxyethyl acrylate, carboxyethyl acrylate, acryloyloxyethyl succinate and combinations thereof. If present, the weight content of said monomer M2 may be lower than 5 wt %, advantageously lower than 4 wt %, preferably lower than 3 wt %, more preferably lower than 2 wt %, in particular lower than 1 wt %.

In another embodiment, said copolymer may also optionally comprises recurring units derived from monomers M3. Said monomer M3 may be (A) an alkenyl compound containing a functional group, or (B) an alkenyl compound without a functional group; or mixtures thereof. The alkenyl compound (A) containing a functional group comprises, for example, α,β-unsaturated carboxylic acids such as acrylic acid, methacrylic acid, fumaric acid, crotonic acid, itaconic acid and the like; vinyl ester compounds such as vinyl acetate, vinyl neodecanoate and the like; amide compounds such as acrylamide, methacrylamide, N-methylacrylamide, N-methylmethacrylamide, N-methylolacrylamide, N-methylolmethacrylamide, N-alkylacrylamide, N-alkylmethacrylamide, N,N-dialkylacrylamide, N,N-dialkylmethacrylamide, diacetone acrylamide and the like; acrylic acid esters such as 2-hydroxyethyl acrylate, N-dialkylaminoethyl acrylate, glycidyl acrylate, n-dodecyl acrylate, fluoroalkyl acrylate and the like; methacrylic acid esters such as dialkylaminoethyl methacrylate, fluoroalkyl methacrylate, 2-hydroxyethyl methacrylate, n-octyl methacrylate, t-butyl methacrylate, glycidyl methacrylate, ethylene glycol dimethacrylate and the like; maleic anhydride, and alkenyl glycidyl ether compounds such as allyl glycidyl ether and the like. Among these, preference is given to acrylic acid, methacrylic acid, itaconic acid, fumaric acid, N-methylolacrylamide, N-methylolmethacrylamide, diacetone acrylamide, 2-hydroxyethyl acrylate, 2-hydroxyethyl methacrylate and allyl glycidyl ether. These compounds may be used alone or as a mixture of two or more. The alkenyl compound without functional group (B) comprises, for example, conjugated dienes such as 1,3-butadiene, isoprene and the like; divinyl hydrocarbon compounds such as divinylbenzene and the like; and alkenyl cyanides such as acrylonitrile, methacrylonitrile and the like. Among these, 1,3-butadiene and acrylonitrile are preferred. These compounds may be used alone or as a mixture of two or more.

In a preferred embodiment, said copolymer may further comprise between 10 ppm and 2 weight % based on the total weight of the copolymer of a surfactant comprising a polyethylene glycol segment and a polypropylene glycol segment. Preferably, said surfactant has a HLB value of 1 to 20, in particular a HLB value from 1 to 5 or from 10 to 15. In particular, the surfactant comprises a polyethylene glycol segment and a polypropylene glycol segment, has a HLB value of 1 to 5 and preferably a weight average molecular weight of from 2500 to 10000 g·mol-1, in particular 5000 to 10000 g·mol-1. Alternatively, the surfactant comprises a polyethylene glycol segment and a polypropylene glycol segment, has a HLB value of 10 to 15 and preferably a weight average molecular weight of from 500 to 2500 g·mol-1. In the present application, the HLB value of the surfactant refers to an HLB value calculated by the Griffin's method.

In one embodiment, said copolymer may comprise recurring units derived from a monomer bearing a functional group selected from the group consisting of carboxylic acid, carboxylic acid anhydride, carboxylic acid ester, epoxy groups, amide, hydroxyl, carbonyl, mercapto, sulfide, oxazoline, phenolic, ester, ether, siloxane, sulfonic, sulfuric, phosphoric or phosphonic. The functionality can be introduced for example by means of the transfer agent used during the synthesis process. The transfer agent can be a polymer of molar mass less than or equal to 20 000 g/mol and bearing functional groups chosen from the groups: carboxylic acid, carboxylic acid anhydride, carboxylic acid ester, epoxy groups, amide, hydroxyl, carbonyl, mercapto, sulfide, oxazoline, phenolic, ester, ether, siloxane, sulfonic, sulfuric, phosphoric or phosphonic. One example of a transfer agent of this type is oligomers of acrylic acid. According to a preferred embodiment, the transfer agent is an oligomer of acrylic acid of molar mass less than or equal to 20 000 g/mol.

In a preferred embodiment, said copolymer is in powder form. The average particles size may be from 0.8 μm to 150 μm, preferably from 1 μm to 100 μm.

### Process for the Preparation of the Copolymer

In another aspect, a process for preparing a copolymer is provided. The copolymer is conveniently made by an emulsion polymerization process, but could also be synthesized by a suspension, solution, or supercritical CO₂ process.

In a preferred embodiment, the process comprises the steps of:
a) Charging to a reactor an initial charge comprising water, surfactant and said fluorinated monomer M1 and adding vinylidene fluoride to the reactor until the operating pressure is reached;
b) Initiating the polymerization by adding an initiator;
c) Continuously feeding vinylidene fluoride and optionally the initiator until all the vinylidene fluoride has been added to the reactor to form the copolymer;
d) Removing the copolymer from the reactor;
e) Optionally drying the copolymer to form a powder.

The fluorinated monomer M1 is defined above in the present application. The weight content of said fluorinated monomer M1 introduced in the reactor throughout the process, and based on the total weight of vinylidene fluoride and said fluorinated monomer M1 introduced in the reactor throughout the process, is defined above with respect to the weight content of said fluorinated monomer M1 in the copolymer.

Preferably, said fluorinated monomer M1 is hexafluoropropene. Preferably, the weight content of said fluorinated monomer M1 introduced in the reactor throughout the process is lower than 11 wt % based on the total weight of vinylidene fluoride and said fluorinated monomer M1 introduced in the reactor throughout the process. The weight content of said fluorinated monomer M1 introduced in the reactor throughout the process may be from 0.1 wt % to 11 wt %, preferably from 0.5 wt % to 11 wt %, more preferably from 1 to 11 wt %, most preferably from 2 to 10 wt %, in particular from 3 to 10 wt %, more particularly from 4 to 10 wt %, most particularly from 4.5 to 9.5 wt % based on the total weight of vinylidene fluoride and said fluorinated monomer M1 introduced in the reactor throughout the process.

Alternatively, the weight content of said fluorinated monomer M1 introduced in the reactor throughout the process is greater than 17 wt % based on the total weight of vinylidene fluoride and said fluorinated monomer M1 introduced in the reactor throughout the process. The weight content of said fluorinated monomer M1 introduced in the reactor throughout the process may be from 17 wt % to 50 wt %, preferably from 18 wt % to 45 wt %, particularly from 18 to 40 wt % based on the total weight of vinylidene fluoride and said fluorinated monomer M1 introduced in the reactor throughout the process.

Furthermore, the whole amount of said fluorinated monomer M1 used in the process is added to the reactor prior to step b). By adding all the fluorinated monomer M1 upfront, i.e. prior to the initiation of the polymerization, the copolymer obtained by the present process exhibits unexpected properties as detailed in the present application.

In step a) of the present process, the initial charge may also comprise an antifoulant, a buffering agent or a molecular weight regulator in any convenient order.

Surfactants useful in the invention include halogenated and non-halogenated surfactants known to be useful for the (co) polymerization of vinylidene fluoride and perfluoroalkyl vinyl ethers. Examples of useful surfactants are partially fluorinated and perfluorinated carboxylic acid salts, described in U.S. Pat. No. 2,559,752; siloxane surfactants, as described in U.S. Pat. No. 6,841,616B2; 3-allyloxy-2-hydroxy-1-propanesulfonic acid salt surfactant, described in U.S. Pat. No. 6,869,997B2; alkyl sulfonate surfactant, described in US20050239983A1; alkyl phosphonic acid its salts (U.S. Pat. No. 8,124,694); polyvinyl phosphonic acid, polyacrylic acid and polyvinylsulfonic acid (U.S. Pat. No. 8,697,822); and non-ionic surfactants containing polyethylene glycol, polypropylene glycol and tetramethylene glycol (U.S. Pat. Nos. 8,080,621, 8,765,890, and 8,158,734).

The surfactant may be non-ionic or ionic, preferably non-ionic.

Preferably, the copolymer formed is fluorosurfactant-free, meaning that no fluoro-surfactants are used in making or processing the polymer. Preferably, the surfactant is a non-ionic surfactant. Hence, the surfactant is particularly non-ionic and non-fluorinated.

In a preferred embodiment, the surfactant comprises a polyethylene glycol segment and a polypropylene glycol segment. Preferably, said surfactant has a HLB value of 1 to 20, in particular a HLB value from 1 to 5 or from 10 to 15. In particular, the surfactant comprises a polyethylene glycol segment and a polypropylene glycol segment and has a HLB value of 1 to 5 and preferably a weight average molecular weight of from 2500 to 10000 g·mol-1, in particular from 5000 to 10000 g·mol-1 (measured by GPC calibrated with polystyrene standard). Alternatively, the surfactant comprises a polyethylene glycol segment and a polypropylene glycol segment, has a HLB value of 10 to 15 and preferably a weight average molecular weight of from 500 to 2500 g·mol-1 (measured by GPC calibrated with polystyrene standard). In the present application, the HLB value of the surfactant refers to an HLB value calculated by the Griffin's method.

The surfactant charge may be from 10 ppm to 2% by weight on the total monomer weight used, preferably from 10 ppm to 1.5 wt %, more preferably from 10 ppm to 1 wt % and most preferably the surfactant charge is from 100 ppm to 0.2% by weight on the total monomer weight used. Normally the surfactant is added during the initial filling of the reactor, but some portion may also be added after the reaction has begun. Surfactant may also be added as the reaction progresses if needed for further stabilization.

A paraffin antifoulant is optionally used in the polymerization. Any long-chain, saturated, hydrocarbon wax or oil may be used. The oil or wax is added to the reactor prior to formation of fluoropolymer, in an amount sufficient to minimize the formation of polymer adhesions to the reactor components. This amount is generally proportional to the interior surface area of the reactor and may vary from about 1 to about 40 mg/cm² of reactor interior surface area. If a paraffin wax or hydrocarbon oil is used as the antifoulant, the amount used is typically about 5 mg/cm² of the reactor interior surface area.

The polymerization reaction mixture may optionally contain a buffering agent to maintain a controlled pH during the polymerization reaction. The pH is typically controlled within the range of from about 3 to about 8, to minimize undesirable color development in the product. The buffering agent may be added all at the beginning, at different points, or throughout the polymerization. Suitable exemplary buffering agents are phosphate buffers and acetate buffers, which are well known in the art.

Molecular weight regulators, also called chain-transfer agents, may optionally be used to adjust the molecular weight profile of the product. They may be added in a single portion at the beginning of the reaction, incrementally, or continuously throughout the reaction. The amount of molecular weight regulator added to the polymerization reaction is typically from about 0.05 to about 5 wt %, more typically from about 0.1 to about 2 wt % based on the total weight of monomer added to the reaction mixture. Oxygenated compounds such as alcohols, carbonates, ketones, esters, and ethers may serve as molecular weight regulators. Examples of suitable oxygenated compounds include isopropyl alcohol, acetone, ethyl acetate, and diethyl carbonate. Other classes of molecular weight regulators include halogenated compounds such as chlorocarbons, hydrochlorocarbons, hydrofluorocarbons, chlorofluorocarbons, and hydrochlorofluorocarbons. Particular examples of halogenated molecular weight regulators include 1-fluoroethane, trichlorofluoromethane, and 1,1-dichloro-2,2,2-trifluoroethane. Some hydrocarbons may be used as molecular weight regulators, such as hydrocarbons that contain two to five carbon atoms, with ethane and propane as particular examples.

Once the reactor is charged with all the starting material in step a), the air may be removed from the reactor. Heat and agitation sufficient to effect polymerization can be provided.

Vinylidene fluoride is provided to the reactor. The reactor is brought to the operating pressure with vinylidene fluoride. The pressure used for polymerization may be selected from a wide range of pressures, from 280 to 20,000 kPa, depending on the capabilities of the reaction equipment, the initiator system chosen, and the monomer composition used. The polymerization pressure is typically from 2,000 to 11,000 kPa, and most typically from 2,750 to 6,900 kPa. The pressure may be adjusted during the reaction to control the process rate and molecular weight profile. The polymerization temperature may vary from 20° C. to 160° C., depending on the initiator system chosen, and is typically from 35° C. to 130° C., and most typically from 65° C. to 95° C. The temperature may also be adjusted during the reaction to control the process rate, initiator efficiency, and product characteristics.

In step b) of the present process, an initiator is added to the reactor. The initiator may be one or a combination of more than one of the initiators known in the art to be useful in the emulsion polymerization of halogenated monomers. Suitable non-limiting classes of initiators include persulfate salts, peroxides, and redox systems. Examples of persulfate salts are sodium persulfate, potassium persulfate, or ammonium persulfate. The amount of persulfate salt added to the reaction mixture based on the total weight of monomer added to the reaction mixture is typically from about 0.005 to about 1.0 wt percent. Organic peroxides that are useful include dialkyl peroxides, alkyl hydroperoxides, peroxy esters, and peroxydicarbonates. A suitable exemplary dialkyl peroxide is di-tert-butyl peroxide. Suitable exemplary peroxy esters include tert-amyl peroxypivalate, tert-butyl peroxypivalate, and succinic acid peroxide. Suitable exemplary peroxydicarbonate initiators include di-n-propyl peroxydicarbonate and diisopropyl peroxydicarbonate, which are typically added to the reaction mixture in an amount based on the total weight of monomer added to the reaction mixture of about 0.5 to about 2.5 wt. %. The initiator may comprise a redox system. By “redox system” is meant a system comprising an oxidizing agent, a reducing agent, and optionally a promoter that acts as an electron transfer medium. The promoter is a component that, in different oxidation states, is capable of reacting with both the oxidant and the reducing agent, thereby accelerating the overall reaction. Oxidizing agents include, for example, persulfate salts; peroxides, such as hydrogen peroxide; hydroperoxides, such as tert-butyl hydroperoxide and cumene hydroperoxide; and oxidizing metal salts such as, for example, ferric sulfate and potassium permanganate. Exemplary reducing agents include sodium formaldehyde sulfoxylate; sodium or potassium sulfite, bisulfite, or metabisulfite; ascorbic acid; oxalic acid; and reduced metal salts. Typical promoters include transition metal salts such as ferrous sulfate. In redox systems, the oxidizing agent and the reducing agent are typically utilized in an amount from about 0.01 to about 0.5 wt. % based on the total weight of monomer added to the reaction mixture. The promoter, if used, is typically employed in an amount from about 0.005 to about 0.025 wt. % based on the total weight of monomer added to the reaction mixture.

In a preferred embodiment, the whole amount of said fluorinated monomer M1 is added to the reactor before step b). By adding all the fluorinated monomer M1 before the initiation of the polymerization, the present process allows the preparation of a copolymer having lower melting temperature, higher crystallinity which will swell less in a Li-ion battery.

Vinylidene fluoride is added to the reaction as necessary to maintain reactor pressure. Optionally more initiator can be added, if needed, to keep the reaction going. The mode of initiator addition depends on the initiator used, the reaction temperature, and the molecular weight characteristics desired.

The amount of fluorinated monomer M1 that is fed to the reactor is an amount that will yield a copolymer as defined above.

The copolymer formed by the process of the invention has a unique morphology, and composition, providing a useful combination of properties.

The higher level of fluorinated monomer M1 added upfront provides better reasonable swelling and improved adhesion than when the fluorinated monomer M1 is added at a latter point in the polymerization. The copolymer of the present invention has a lower melting point than other copolymers produced by adding the fluorinated monomer at a latter point in the polymerization process.

As detailed above, the copolymer of the present invention produced by the present process may also contain recurring units derived from monomers M2 or M3 defined above. Said monomers M2 and M3 may be added in steps a), b) and/or c). The content of monomers M2 and M3 added throughout the process is adapted to the desired amount thereof in the copolymer so-produced.

### Uses

In another aspect of the present invention, an article formed from the copolymer according to the present invention is provided. The unique properties of the copolymer of the invention make them especially useful in several final applications. These include but are not limited to the wire & cable market, oil & gas market, and the food and beverage tubing market. The copolymer of the invention can be formulated with additives commonly used in polymer compounding for specific end uses, including but not limited to, plasticizers, antioxidants, flame retardants, fillers, fibers, thermal stabilizers, waxes, lubricants, metal oxides, colorants, conductive fillers, antistatics, and antimicrobial agents.

In a preferred embodiment, said article is selected from the group consisting of jacketing, primary layer, buffer layer or strength member for a wire or cable, a filtration membrane, a battery separator or electrode, a protection or adhesive layer for electrode; a foamed article; a tube, film, sheet, rod or fiber; a gasket; an umbilical or riser for oil and gas applications; an oil and gas tank liners, a tubing, bags or containers for sterile uses, pharmaceutical production and distribution, food and beverage contact, and biological applications; corrosion resistant powder coatings for metal substrates, extruded sheet linings for tank fabrication on metal or as dual laminate and products produced using articles mentioned herein.

In particular, a separator for a lithium ion battery is provided. In particular, the separator for a lithium-ion battery comprises an adhesive layer on at least one side of a porous substrate, wherein the adhesive layer comprises the copolymer according to the present invention or the interpenetrated polymer network according to the present invention. The expression interpenetrated polymer network preferably encompasses a semi-interpenetrating polymer network defined as a polymer comprising one or more polymer networks and one or more linear or branched polymers characterized by the penetration on a molecular scale of at least one of the networks by at least some of the linear or branched macromolecules.

In one embodiment, the adhesive layer comprises 50 to 99 weight percent of inorganic particles, based on the combined weight of polymer and inorganic particles. Preferably, said inorganic particles are selected from the group consisting of BaTiO₃, Pb(Zr,Ti)O₃, Pb₁₋ₓLaₓZr_{y}O₃ (0<x<1, 0<y<1), PbMg₃Nb_{2/3}O₃, PbTiO₃, hafnia (HfO, HfO₂), SrTiO₃, SnO₂, CeO₂, MgO, NiO, CaO, ZnO, Y₂O₃, boehmite (y-AlO(OH)), Al₂O₃, TiO₂, SiC, ZrO₂, boron silicate, BaSO₄, nanoclays, or mixtures thereof.

Preferably, the thickness of the adhesive layer over at least one side of the porous substrate is from 0.5 to 10 micrometres.

The porous substrate may take the form of a membrane or of a fibrous fabric. When the porous substrate is fibrous, it may be a nonwoven web forming a porous web, such as a web obtained by direct spinning or melt blowing (of spun bond or melt blown type).

Examples of porous substrates comprise, without being limited thereto: polyolefins, polyethylene terephthalate, polybutylene terephthalate, polyester, polyacetal, polyamide, polycarbonate, polyimide, polyether ether ketone, polyether sulfone, poly(phenylene oxide), poly(phenylene sulfide), polyethylene naphthalate, or mixtures thereof. However, other engineering plastics that are resistant to heat may be used, without particular limitation. Non-woven materials made of natural or synthetic materials may also be used as the substrate of the separator. The porous substrate generally has a thickness of from 1 to 50 μm, typically being membranes obtained by extrusion and drawing (wet or dry processes) or cast nonwovens. The porous substrate preferably has a porosity of between 5% and 95%. The average size of the pores (diameter) is preferably between 0.001 and 50 μm, more preferably between 0.01 and 10 μm.

Alternatively, the copolymer of the present invention can be used as binder in a positive or negative electrode.

In another aspect of the present invention, an electrode composition is provided. The electrode composition comprises the copolymer of the present invention, conductive agents and an active material.

The conductive agents is preferably selected from the group consisting of carbon blacks, such as acetylene black, Ketjen black; carbon fibers, such as carbon nanotube, carbon nanofiber, vapor growth carbon fiber; metal powders such as SUS powder, and aluminum powder; or mixtures thereof.

When the electrode is a positive electrode, the active material is preferably selected from the group consisting of lithium-salts of transition metal oxides, sulfides, phosphate and hydroxides. Preferably, said active material is selected from the group consisting of a lithium metal phosphate having a composition represented by LiMPO₄, M representing Fe, Mn, Co, or Ni, LiCoO₂, LiNiₓCo₁₋ₓO₂, LiMn₂O₂, LiNiO₂, LiNiₓCo_{y}Mn₂Oₘ, LiNiₓCo_{y}Al₂Oₘ and LiNiₓMn_{y}Al₂Oₘ where x+y+z=1 and m is an integer representing the number of oxygen atom in the oxide to provide an electron-balanced molecule. More preferably, said active material is selected from the group consisting of LifePO₄ and LiNiₓCo_{y}Mn₂Oₘ wherein x is greater than or equal to 0.6, y is lower than or equal to 0.2, z is greater than or equal to 0.2, and x+y+z=1 and m is an integer representing the number of oxygen atom in the oxide to provide an electron-balanced molecule. In particular, said active material is selected from the group consisting of LifePO₄ and LiNiₓCo_{y}Mn₂Oₘ wherein x is greater than or equal to 0.8, y is lower than or equal to 0.1, z is greater than or equal to 0.1, and x+y+z=1 and m is an integer representing the number of oxygen atom in the oxide to provide an electron-balanced molecule

When the electrode is a negative electrode, the active material is preferably selected from the group consisting of carbon-based material such as graphite-based carbon, coke-based carbon and hard carbon, silicon, lithium alloy, metallic oxide, alloy of silicon and Li₄Ti₅O₁₂.

The electrode composition may further comprise a solvent such as water or an organic solvent.

The organic solvent is preferably selected from the group consisting of n-methylpyrrolidone (NMP), dimethylsulfoxide (DMSO), N,N-dimethylformamide (DMF), triethylphosphite (TEP), acetone, cyclopentanone, tetrahydrofuran, methyl ethylketone (MEK), methyl isobutyl ketone (MiBK), ethyl acetate (EA), butyl acetate (BA), ethylene carbonate (EC), propylene carbonate (PC), dimethyl carbonate (DMC), diethyl carbonate (DEC), ethyl methyl carbonate (EMC), gamma-butyrolactone and N-butylpyrrolidone; and combinations thereof.

The electrode composition is usually prepared by mixing the components, i.e. copolymer, the active material, the conductive agent and optionally the solvent. When the components are mixed in the presence of an organic solvent, the copolymer is preferably in a powder form.

In another aspect of the present invention, an electrode is provided. Said electrode comprises a current collector and said electrode composition according to the present invention disposed on at least one surface on said current collector. Once said electrode composition is disposed on at least one surface on said current collector, the electrode is dried to remove the organic solvent or water. According to a preferred embodiment, after evaporation of the organic solvent or water, the electrode composition cast on the current collector has the following mass composition:
a. 80% to 99.9% active material, preferably 80% to 99%,
b. 0.05% to 10% conductive agent, preferably 10% to 0.5%,
c. 0.05% to 10% copolymer of the present invention, preferably 10% to 0.5%; the sum of all these percentages being 100%.

The present invention also provides a Li-ion secondary battery. Said Li-ion secondary battery comprises a negative electrode, a positive electrode according to the present invention and a separator between the negative electrode and the positive electrode. Alternatively, said Li-ion secondary battery comprises a negative electrode according to the present invention, a positive electrode and a separator between said negative electrode and said positive electrode.

In another aspect of the present invention, an electrochemical device is provided. Said electrochemical device comprises a negative electrode, a positive electrode according to the present invention and an electrolyte comprising lithium. Alternatively, said electrochemical device comprises a negative electrode according to the present invention, a positive electrode and an electrolyte comprising lithium.

The present invention also provides a solid state battery comprising the copolymer of the present invention.

### EXAMPLES

The SEM images provided have been produced using samples prepared after a solvent extraction process for removal of the rubber phase. In all these images, being viewed is what remains after removal of the rubber phase from the solvent extraction process. The steps involved in preparing the samples is described as follows:
a. Cutting a solid polymer sample with a band saw (Southbay Technologies, model 865) into rectangular pieces, 8 to 12 mm long, and with lateral dimensions of 2 to 3 mm
b. Placing the polymer sample into the sample holder (Boeckeler Instruments) of a microtome instrument.
c. Cut the sample top into a four sided pyramid with an apex to base distance of 3 to 5 mm using a glass knife (Alkar, Sweden).
d. Cryomicrotoming the sample using a Cryomicrotome instrument (Boeckeler Instruments, Powertome CRX with CRX cryomicrotome unit) using glass and diamond knives at −120 degrees centigrade A glass knife is used to make parallel slices from the sample apex down to 0.5 to 0.8 mm below the apex (1 to 10 micrometer slices) followed by a diamond knife (Diatome, model histo-cryo) used to remove two 1 micrometer thick slices, two 250 nm thick slices, and one 100 nm thick slice.
e. The sample is taken out of the microtome holder and allowed to dry at room temperature until water condensation is no longer visible and is then immersed into acetone for 10 hours at room temperature using a suitable glass vessel.
f. After 10 hours of immersion, the sample is taken out of the acetone solution and left to dry at room temperature for one hour before SEM analysis.
Melting temperature: Polymer melting points were determined by differential scanning calorimetry (DSC) following the procedure detailed in ASTM E794-06 2018. Resin samples were heated, cooled, and reheated at 10 degrees centigrade/min from −20 degrees centigrade to 210 degrees centigrade. The melting point was taken to be the peak temperature value of the melting transition during the second heating cycle.
Heat of fusion: Heat of fusion was determined by differential scanning calorimetry (DSC) following the procedure detailed in ASTM E793-06 2018 during the first heating cycle.
Swelling: The swelling data were determined in EC/EMC/DEC=3/5/2 electrolyte at room temperature. The samples were prepared as 1 mm film by hot press. The weight gain data were recorded at 7 days.
NMR Analysis: Copolymer compositions were determined by 19F NMR by first dissolving the resin sample in a solvent mixture of triethylphosphite and tetrahydrofuran-d8. Solution 19F NMR spectra were acquired at 50 degrees centigrade on a Bruker AV III HD 500 MHz spectrometer (11.7 T) equipped with a 5 mm 1H/19F/13C TXO probe. From the spectra, the molar ratios of HFP and VDF were then determined by comparing the integrals of the CF₃ and CF₂ signals. Weight fractions were then calculated by multiplying the molar ratios by the respective monomer molecular weights.
Melt viscosity: The melt viscosity is measured according to ASTM method D3835 measured at 232° C. and 100 sec⁻¹.

### Example 1

To a 2 gallon autoclave, 4000 g of deionized water and 2.0 g surfactant (Pluronic 31R¹) was charged. The contents of the autoclave were freed of oxygen by pressurizing to 60 psig with nitrogen and agitating at 60 rpm followed by venting to atmospheric pressure. This purging sequence was performed three times. Following, the reactor was sealed, agitated, and heated to 100° C. The reactor was then charged with 222 g hexafluoropropylene (HFP). Next, the reactor was pressurized to 650 psig with vinylidene fluoride (VDF). A feed of 1.0 wt % potassium persulfate (KPS) and 1.0 wt % sodium acetate trihydrate (SAT) was started at 240 mL/hr. Upon pressure drop, vinylidene fluoride was fed to the reactor at a rate necessary to maintain pressure at 650 psig throughout the reaction. Once VDF feed rose to 1000 ml/hr, the KPS/SAT feed was decreased to 100 ml/hr, then to 50 mL/hr, then 25 mL/hr. KPS/SAT feed rates were selected to maintain steady feed of VDF around 1000/mL hr. Once 1679 g VDF was fed, the VDF feed was stopped. KPS and SAT feed was continued at 25 mL/hr for an additional 40 minutes. The reactor was cooled to 75° C. and vented to atmospheric pressure. Following venting, the reactor was cooled to room temperature and the product was discharged from the reactor. The product was directly spray dried with a 160° C. inlet temperature and 90° C. outlet temperature. The HFP content in the product is 9.1 wt. %. The melting point is 138.7° C.

### Example 2

To a 2 gallon autoclave, 4000 g of deionized water and 2.0 g surfactant (Pluronic 31R¹) was charged. The contents of the autoclave were freed of oxygen by pressurizing to 60 psig with nitrogen and agitating at 60 rpm followed by venting to atmospheric pressure. This purging sequence was performed three times. Following, the reactor was sealed, agitated, and heated to 100° C. The reactor was then charged with 184 g hexafluoropropylene (HFP). Next, the reactor was pressurized to 650 psig with vinylidene fluoride (VDF). A feed of 1.0 wt % potassium persulfate (KPS) and 1.0 wt % sodium acetate (SAT) was started at 240 mL/hr. Upon pressure drop, vinylidene fluoride was fed to the reactor at a rate necessary to maintain pressure at 650 psig throughout the reaction and KPS/SAT feed was decreased to 100 mL/hr, then to 50 mL/hr, then 25 mL/hr. KPS/SAT feed rates were selected to maintain steady feed of VDF around 1000/mL hr. Once 1720 g VDF was fed, the VDF feed was stopped. KPS and SAT feed was continued at 25 mL/hr for an additional 30 minutes. The reactor was cooled to 75° C. and vented to atmospheric pressure. Following venting, the reactor was cooled to room temperature and the product was discharged from the reactor. The product was directly spray dried with a 160° C. inlet temperature and 90° C. outlet temperature. The HFP content in the product is 7.3 wt. %. The melting point is 140.8° C.

### Example 3

To a 2 gallon autoclave, 4000 g of deionized water and 2.0 g surfactant (Pluronic 31R¹) was charged. The contents of the autoclave were freed of oxygen by pressurizing to 60 psig with nitrogen and agitating at 60 rpm followed by venting to atmospheric pressure. This purging sequence was performed three times. Following, the reactor was sealed, agitated, and heated to 100° C. The reactor was then charged with 146 g hexafluoropropylene (HFP). Next, the reactor was pressurized to 650 psig with vinylidene fluoride (VDF). A feed of 1.0 wt % potassium persulfate (KPS) and 1.0 wt % sodium acetate (SAT) was started at 240 mL/hr. Upon pressure drop, vinylidene fluoride was fed to the reactor at a rate necessary to maintain pressure at 650 psig throughout the reaction and KPS/SAT feed was decreased to 100 mL/hr, then to 50 mL/hr, then 25 mL/hr. KPS/SAT feed rates were selected to maintain steady feed of VDF around 1000/mL hr. Once 1751 g VDF was fed, the VDF feed was stopped. KPS and SAT feed was continued at 30 mL/hr for an additional 30 minutes. The reactor was cooled to 75° C. and vented to atmospheric pressure. Following venting, the reactor was cooled to room temperature and the product was discharged from the reactor. The product was directly spray dried with a 160° C. inlet temperature and 90° C. outlet temperature. The HFP content in the product is 5.8 wt. %. The melting point is 145.0° C.

### Example 4

Example 1 was reproduced except that the amount of hexafluoropropene (HFP) was adapted to produce a copolymer having a HFP content of 10.8 wt %.

Table 1 below lists the data obtained for the product prepared in examples 1~4

TABLE 1

| | | |
|---|---|---|
| | | Melting |
| | HFP content | point |
| Example | (by NMR) | (° C.) |

| | | | | |
|---|---|---|---|---|
| Example 1 | 9.1 | wt % | 138.7° | C. |
| Example 2 | 7.3 | wt % | 140.8° | C. |
| Example 3 | 5.8 | wt % | 145° | C. |
| Example 4 | 10.8 | wt % | 133° | C. |
| Comp. ex 1 | 4.55 | wt % | 155.8° | C. |
| Comp. ex. 2 | 9.97 | wt % | 141.5° | C. |

Copolymers of the comparative examples 1 and 2 were obtained by a process wherein the hexafluoropropene is added continuously throughout the process along with vinylidene fluoride. As shown in FIG. 2, the copolymers of the present invention exhibit lower melting temperature than the comparative copolymers. Hence, the processability of the copolymers of the present invention is improved at a defined hexafluoropropene content.

The swelling at room temperature was measured for copolymers of example 2 and comparative example 2. The swelling for example 2 was of 32.7% whilst the swelling of comparative example 2 was of 49.7%. The copolymer of the present invention shows lower swelling than other copolymers having substantially similar melting temperature. According to the present invention, it is possible to produce copolymers having low melting temperature using less hexafluoropropene. By minimizing the hexafluoropropene content in the copolymer, the swelling is therefore decreased.

Other copolymers having higher HFP content were also prepared in examples 5-7.

### Example 5

To a 2 liter autoclave, 1000 g of deionized water and 0.6 g surfactant (Pluronic 31R¹) was charged. The contents of the autoclave were freed of oxygen by pressurizing to 60 psig with nitrogen and agitating at 60 rpm followed by venting to atmospheric pressure. This purging sequence was performed three times. Following, the reactor was sealed, agitated at 72 rpm, and heated to 100 C. The reactor was then charged with 90 g hexafluoropropylene (HFP). Next, the reactor was pressurized to 650 psig with vinylidene fluoride (VDF). A feed of 1.0 wt % potassium persulfate (KPS) and 1.0 wt % sodium acetate trihydrate (SAT) was started at 180 mL/hr. Upon pressure drop, vinylidene fluoride was fed to the reactor at a rate necessary to maintain pressure at 650 psig throughout the reaction. Once pressure drop occurred, the KPS/SAT feed was decreased to maintain steady feed of VDF around 100-300/mL hr. Once 360 g VDF was fed, the VDF feed was stopped. KPS and SAT feed was continued at 20 mL/hr for an additional 31 minutes. The reactor was cooled to 30° C. and vented to atmospheric pressure. Following venting, the product was discharged from the reactor. The product was oven dried at 60° C.

### Example 6

To a 2 liter autoclave, 1000 g of deionized water and 0.6 g surfactant (Pluronic 31R¹) was charged. The contents of the autoclave were freed of oxygen by pressurizing to 60 psig with nitrogen and agitating at 60 rpm followed by venting to atmospheric pressure. This purging sequence was performed three times. Following, the reactor was sealed, agitated at 72 rpm, and heated to 100 C. The reactor was then charged with 134 g hexafluoropropylene (HFP). Next, the reactor was pressurized to 650 psig with vinylidene fluoride (VDF). A feed of 1.0 wt % potassium persulfate (KPS) and 1.0 wt % sodium acetate trihydrate (SAT) was started at 180 ml/hr. Upon pressure drop, vinylidene fluoride was fed to the reactor at a rate necessary to maintain pressure at 650 psig throughout the reaction. Once pressure drop occurred, the KPS/SAT feed was decreased to maintain steady feed of VDF around 100-300/mL hr. Once 315 g VDF was fed, the VDF feed was stopped. KPS and SAT feed was continued at 40 mL/hr for an additional 35 minutes. The reactor was cooled to 30° C. and vented to atmospheric pressure. Following venting, the product was discharged from the reactor. The product was oven dried at 60° C.

Table 2 below lists the data obtained for the product prepared in examples 5-7

TABLE 2

| | HFP | Melt | Melting | |
|---|---|---|---|---|
| | content | viscosity | point | |
| Example | (by NMR) | (kP, 100 s⁻¹) | (° C.) | |
| Example 5 | 18.5 wt % | 20.80 | 115.7° | C. |
| Example 6 | 32.6 wt % | 9.60 | 92.2° | C. |

The present invention allows the preparation of a wide range of copolymers having improved properties.

Other copolymers according to the present invention were prepared according to the same protocol used in example 1. The heat of fusion was determined and is reported in Table 3 below.

TABLE 3

| | HFP | Heat of | Melting | |
|---|---|---|---|---|
| Example | content | fusion | temperature | |
| Example 7 | 6.1 wt % | 27.5 J/g | 140.7° | C. |
| Example 8 | 7.9 wt % | 26.1 J/g | 138° | C. |
| Example 9 | 4.6 wt % | 30.7 J/g | 146° | C. |

1. A copolymer comprising recurring units derived from vinylidene fluoride and recurring units derived from a fluorinated monomer M1; said copolymer having a melting temperature Tm defined by the relationship:
(154.45−1.9472*x)−3<Tm (° C.)<(154.45−1.9472*x)+3
wherein x is the weight content expressed as percent of said fluorinated monomer M1 based on the total weight of said copolymer; the melting temperature being measured by DSC according to the ASTM E794-06 (2018) standard test method; wherein the fluorinated monomer M1 is hexafluoropropene and wherein the weight content of hexafluoropropene based on the total weight of said copolymer is lower than 11 wt %.

2. The copolymer of claim 1, wherein the weight content of said fluorinated monomer M1 is from 0.1 wt % to 11 wt % based on the total weight of the copolymer.

3. The copolymer of claim 1, wherein said copolymer has a heat of fusion ΔH defined by the relationship: (34.517−1.0125*x)−2.2<ΔH (J/g)<(34.517−1.0125*x)+2.2; wherein x is the weight content of said fluorinated monomer M1 expressed as percent based on the total weight of said copolymer; the heat of fusion being determined by DSC according to the ASTM E793-06 (2018) standard test method.

4. The copolymer of claim 1, further comprising recurring units derived from a hydrophilic monomer M2 of formula R¹R²C═C(R³)C(O)R (I) wherein R¹, R² and R³ are independently selected from the group consisting of H and C₁-C₈ alkyl; R is selected from the group consisting of —NHC(CH₃)₂CH₂C(O)CH₃, —NR′R″ or —OR′ wherein R′ and R″ are independently selected from the group consisting of H and C₁-C₁₈ alkyl groups, optionally substituted by one or more hydroxyl, carboxyl, thiol or amino functional group(s) or a five- to six-membered heterocycle comprising at least one nitrogen atom in the ring.

5. The copolymer of claim 1, further comprising recurring units derived from a monomer bearing a functional group selected from the group consisting of carboxylic acid, carboxylic acid anhydride, carboxylic acid ester, epoxy groups, amide, hydroxyl, carbonyl, mercapto, sulfide, oxazoline, phenolic, ester, ether, siloxane, sulfonic, sulfuric, phosphoric and phosphonic.

6. The copolymer of claim 1, wherein said copolymer is in powder form.

7. (canceled)

8. (canceled)

9. A process for preparing a copolymer, comprising the steps of:
a) Charging to a reactor an initial charge comprising water, surfactant, a fluorinated monomer M1 and adding vinylidene fluoride to the reactor until the operating pressure is reached;
b) Initiating the polymerization by adding an initiator;
c) Continuously feeding vinylidene fluoride and optionally the initiator until all the vinylidene fluoride has been added to the reactor to form the copolymer;
d) Removing the copolymer from the reactor;
e) Optionally drying the copolymer to form a powder;
wherein the weight content of said fluorinated monomer M1 introduced in the reactor throughout the process is lower than 11 wt % based on the total weight of vinylidene fluoride and said fluorinated monomer M1 introduced in the reactor throughout the process; and wherein the whole amount of said fluorinated monomer M1 used in the process is added to the reactor prior to step b).

10. A The process of claim 9, wherein said fluorinated monomer M1 is selected from the group consisting of hexafluoropropene, tetrafluoroethylene, chlorotrifluoroethylene, vinyl fluoride, pentafluoropropene, tetrafluoropropene, trifluoroethylene, perfluoromethyl vinyl ether, perfluoroethyl vinyl ether, and perfluoropropyl vinyl ether.

11. A The process of claim 9, wherein said fluorinated monomer M1 is hexafluoropropene.

12. (canceled)

13. A The process of claim 9, wherein the surfactant comprises a polyethylene glycol segment and a polypropylene glycol segment, has a HLB value of 1 to 5 and a weight average molecular weight of from 2500 to 10000 g·mol-1.

14. A The process of claim 9, wherein a hydrophilic monomer M2 is added in any one of steps a), b) and/or c), and said hydrophilic monomer M2 is of formula R¹R²C═C(R³)C(O)R (I) wherein R¹, R² and R³ are independently selected from the group consisting of H and C₁-C₅ alkyl; R is selected from the group consisting of —NHC(CH₃)₂CH₂C(O)CH₃, —NR′R″ or —OR′ wherein R′ and R″ are independently selected from the group consisting of H and C₁-C₁₈ alkyl groups, optionally substituted by one or more hydroxyl, carboxyl, thiol or amino functional group(s) or a five- to six-membered heterocycle comprising at least one nitrogen atom in the ring.

15. An article formed from the copolymer of claim 1.

16. A separator for a lithium-ion battery comprising an adhesive layer on at least one side of a porous substrate, wherein the adhesive layer comprises the copolymer of claim 1, and optionally inorganic particles.

17. A positive electrode composition or a negative electrode composition comprising the copolymer of claim 1.

18. (canceled)

19. (canceled)

20. A copolymer comprising recurring units derived from vinylidene fluoride and recurring units derived from a fluorinated monomer M1; said copolymer having a melting temperature Tm defined by the relationship:
(154.45−1.9472*x)−3<Tm (° C.)<(154.45−1.9472*x)+3
wherein x is the weight content of said fluorinated monomer M1 expressed as percent based on the total weight of said copolymer; the melting temperature being measured by DSC according to the ASTM E794-06 (2018) standard test method; wherein the fluorinated monomer M1 is hexafluoropropene and wherein the weight content of hexafluoropropene based on the total weight of said copolymer is greater than 17 wt %.

21. The copolymer of claim 20, wherein the weight content of said fluorinated monomer M1 is from 17 wt % to 50 wt % based on the total weight of the copolymer.

22. (canceled)

23. (canceled)

24. (canceled)

25. (canceled)
